(19) United States
(12) Patent Application Publication
(10) Pub. No.: US 2014/0227094 A1
(43) Pub. Date: Aug. 14, 2014

(54) SAILING WINDMILL, FULLY RESPONSIVE VAWT

(71) Applicant: Zhong Ai XIA, Pittsburgh, PA (US)

(72) Inventor: Zhong Ai XIA, Pittsburgh, PA (US)

(21) Appl. No.: 13/762,609

(22) Filed: Feb. 8, 2013

(51) Int. Cl. F03D 1/06

(52) U.S. Cl. CPC F03D 1/0633
USPC 416/9

(57) ABSTRACT

The present invention relates to a vertical axis windmill. The windmill rotates on an upright post, with plural arms holding articulated working members circling around. Each working member has a pivotal edge like a vane, a flag or a hinged door, swings on its own axis and also circles around the axis of the central post. On the axis of each working member furnished a special hinge bearing to control and restrain the movement of each, flipping and engaging the favorable wind in about ¾ turn of the central axis but disengaging in the rest ¼ turn. The said hinge bearing also provides elastic releasable means, along with a centrifugal governor, to deal with excessive wind, allowing the working member to disengage to a temporary idle position as a free weather vane.

### BACKGROUND OF THE INVENTION

As the inventor noticed that a modern HAWT <Horizontal Axis Wind Turbine with airfoil> stops working on low speed wind, while some sailing boats are still sailing around nearby. That means the boat sail is more efficient to capture the wind.

The efficiency of HAWT, ideally, can be 59.3 percent, in reality, maybe somewhere around 35 percent.

The drawback of a HAWT is that: it is not good at dealing with frequent changes of variable wind conditions; it needs to orientate the direction of the wind; it is very expensive for manufacture, installation and maintenance. Also, it kills birds by accident, about 400,000 a year by some estimates.

VAWT, a vertical axis wind turbine, is more visually appealing, and in theory, should have some advantages over HAWT. But so far both two major VAWT designs have the same drawback: Efficiency. The Savonius rotor's efficiency range 5 to 10 percent, as for Darrieus model with airfoil design VAWT, maybe 30 percent. And sometimes they cannot even start by themselves.

The VAWT and sailing boats share the same upright blade or sail, but why VAWT cannot do better than HAWT?

The drawback of most VAWT's efficiency in large part was because of the additional drag that they have as the back of the blades rotate into the wind.

The key is all these airfoil impeller blades are fixed rigid, by no means to adjust to an optimal angle and avoid the negative impact simultaneously in every single turn. Some other inventions dealt with this issue but did not get a feasible solution.

So there is really something valuable to learn from the boat sail. If we can put boat sails on a VAWT, and find some simple and effective way to control the angle of the sail in response to the wind directly, the result will be greatly different.

Based on the idea, the inventor made a tiny model the size of a toy top, using a piece of thick paper, some paper clips and parts of a pen, and it works! It can start by itself in any direction of the wind. Then I put another one on top of the same post, upside down, in front of a fan, again, both work, but spin in opposite directions from each other!

### PRIOR ART

The present invention related to U.S. patent classification 416: FLUID REACTION SURFACES (I.E., IMPELLERS)

A thorough search of class 416/44, 416/46, 416/119, 416/131, 416/132 was made but found nothing more novel.

A discussion of “Notice of References Cited” Feb. 3, 2014 related to the following prior art which was within those most similar, each contains one or some issues:
A_U.S. Pat. No. 1,249,206 A_December 1917, Charles Edgar Rubottom
   Discussion: The issue is if the size of the top wind vane for orientation purpose is not relatively tremendous enough to hold its place according to the wind direction, it would be pushed away from the direction by working members rather than being a reference base of direction pointer to control others.
B_U.S. Pat. No. 2,406,268 A_August 1946, Cornelius F Terhune
   Discussion: The whole structure is unnecessarily extremely complicated. The stops 34 and 34a are not installed in right position so the windmill at best could work only half of every turn instead of as claimed “present to the full force of the wind twice during each revolution”. It is very hard to operate simultaneously without interfering the spinning of the vanes, it has to be shutdown manually on excessive wind, and also not easy to restore aftermath.
C_U.S. Pat. No. 4,496,283 A_January 1985, Andrej A. Kodric
   Discussion: The design is impractical; the position and angle of control means is not correct; the device at best could work only half of each rotation effectively.
D_U.S. Pat. No. 1,794,930 A_March 1931, Charles H Spencer
   Discussion: The design was over-complicated, not feasible and at best the device could only work half of each turn.
E_U.S. Pat. No. 3,897,170 A_July 1975, Arthur Darvishian
   Discussion: The design was different and not feasible
F_U.S. Pat. No. 485,933 A_November 1892, David C. Herman
   Discussion: The angle of the working members' movement is pertinent but by no possible means to deal with excessive wind since all the working members are restrained within two rings and stop rods therefore the whole device is set to rotate in whatsoever condition of wind until being destroyed by immoderate wind.

### BRIEF SUMMARY OF THE INVENTION

The present invention is a solution to all the existing problems with the prior art of the kind, endeavors to provide a simple, low cost yet efficient and reliable vertical axis windmill, featuring:
Work on three quarters of each revolution of the central axis on favorable wind and avoid the negative impact of the rest.
Self-start without extra mechanism other than mere response of the working members to the wind exerted on them.
Work with all wind directions, all wind conditions.
Over-load and over-speed protection by allowing the working member to disengage temporary then restore during each revolution.

### BRIEF DESCRIPTION OF THE SEVERAL VIEWS OF THE DRAWING

FIG. 1: Shows the top view of a 12 o'clock plan.

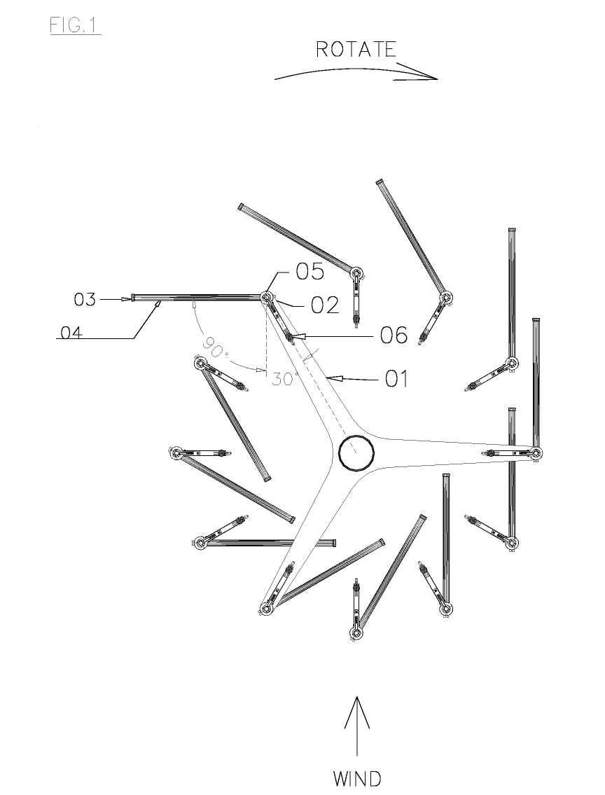

FIG. 2: A perspective SW isometric view

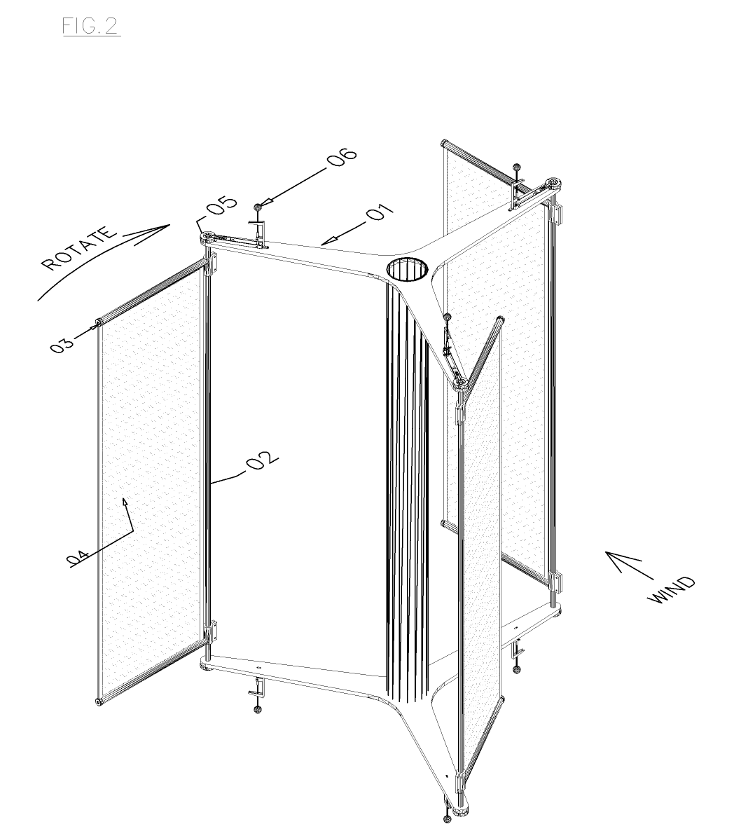

FIG. 3: Partial view around 11 o'clock

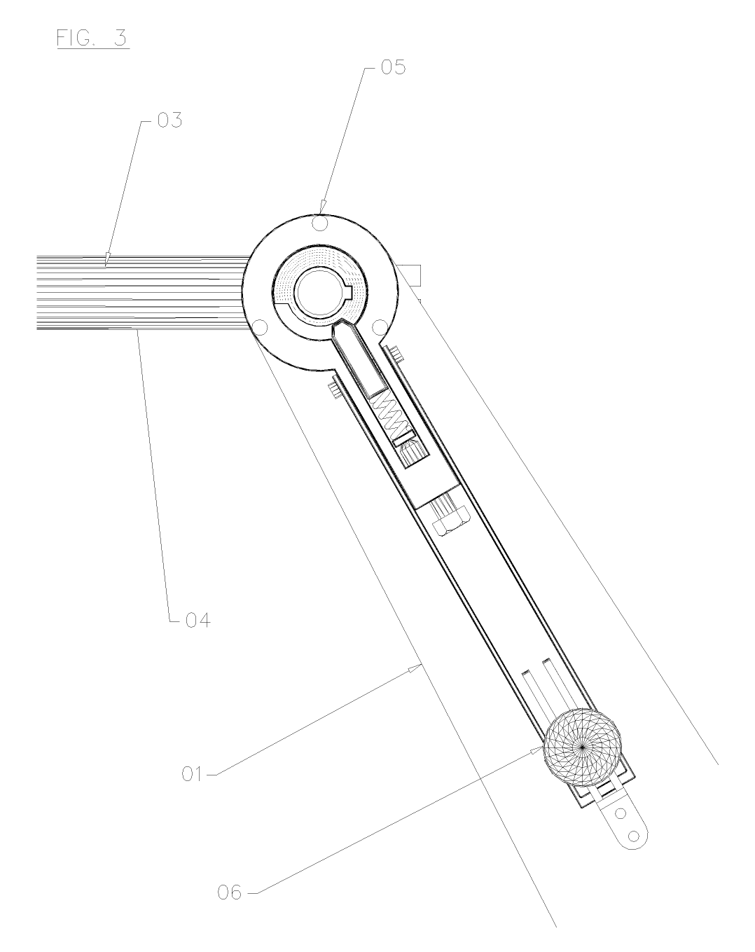

FIG. 4: A perspective partial view of the upper part around 11 o'clock.

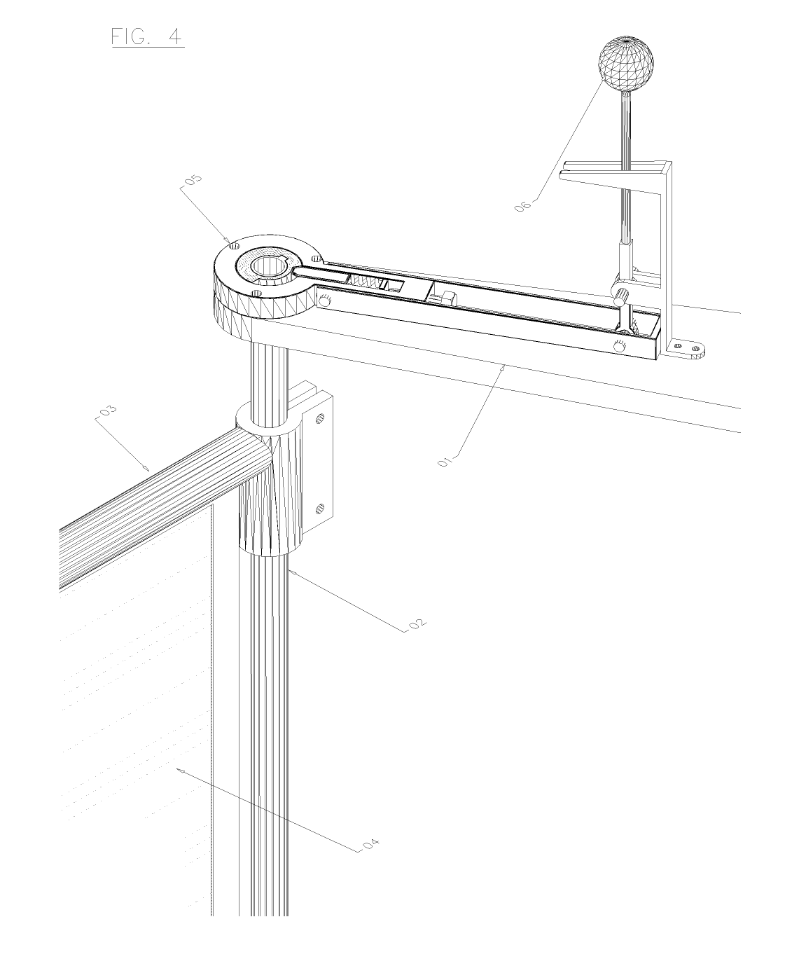

Something did not show in the drawing and can be different for various applications: Bearings, bearing caps, bolts, transmission and generator or storage.

### DETAILED DESCRIPTION OF THE INVENTION

The present Invention relates to a windmill comprising plural working members pivotally attached to a rotor structure 01 to rotate around a vertical central axis.

The said rotor structure 01 includes upper and lower arms along with a central shaft and bearings.
On each far end of said upper and lower arms bored holes or cavities to contain bearings etc. for working members.

Each working member incorporates:
Elbow shaft or satellite shaft 02 with bearings (not shown) installed on both ends.
A pair of forearms 03 is attached on the said elbow shaft, holding and turning with the working part 04.
The working part 04 is equivalent to a square sail, a vane, a blade or a wing, suggesting a piece of sail cloth with 2 rods on both upper and lower ends to insert into the slots of said forearms 03 for easy installation.
At least one end of each elbow shaft 02 furnished a special hinge bearing 05, functioning as a releasable bumper stop to control whether swinging or pivoting of each working member.
   The hinge bearing's inner race is a radial cam with a portion of concaved surface, fixed on the elbow shaft 02.
   The outer race of the said hinge bearing 05 is mounted on the far end of arm 01 with a slotted tail containing:
   A releasable follower backed with a helical spring, elastically coupling into the concave of the said inner race.
   Each hinge bearing 05 is working with a centrifugal governor 06, including a ball weight, a lever with connection and support, to pull back the said follower of bearing 05 into disengaging position in case of the wind exceeds the predetermined level.
   Alternatively, the said centrifugal governor 06 could use the weight of said follower in the hinge bearing 05, providing the said follower designed to be the proper weight and to withdraw outward from the central axis, that way would make the design even simpler with less parts.

The movement of the special hinge bearing 05 is configured to allow the working-part 04 to skew to center-to-bolt radius line of the arm 01 about 30° then swing out 90°, or to allow the same 04 to go beyond the restraint in response to excessive wind then continue to turn around to the next working position.

The device is set to work in such a manner; Suppose the wind blows on a clock pointing the direction of from 6 o'clock to 12 o'clock, with a working member installed on the far end of short hand. At 6 o'clock one side of a working part 04 is facing the wind and pushes the windmill to rotate clockwise until 11 o'clock, then the same 04 swings to other side and continues to push positively until 2 o'clock, at this point the 04 is set free to go against the unfavorable wind like a weather vane until 5 o'clock.

The device could start by itself in any direction of wind, no need of any extra components or sensors for orientation of the wind.

Additionally, the new device is more obvious to birds. Hopefully, this guy will scare away the birds when they approach, and even if some silly birds do fly into it, by nature of the design, pretty much the sails (working part 04) will push away or throw out the victims instead of cutting or killing them. Also, unlike HAWT which is only good at high speed, this machine works even better at low RPM and heavy load like boat sail, and easy to disengage or stop whenever necessary, for example, make a remote or automatic stop on the arriving of flocks of birds.

1. (canceled)

2. A windmill comprising:
a central shaft being rotatable about its longitudinal axis;
a rotor structure 01 mounting on the central shaft with upper and lower arms to hold plural rotatable working members equal spaced on the bolt circle of far end of the said rotor arms;
each working member comprising:
working part 04 or a piece of sail cloth along with a pair of forearms 03 mounted on elbow shaft or satellite shaft 02 which is parallel to the central axis with bearings on both ends including
at least one special hinge bearing 05 to control whether swinging or pivoting of each working member, including
an inner race which is a radial cam with a portion of concaved surface being mounted on the elbow shaft 02 and
an outer race being mounted on the far end of rotor arm 01, with a slotted tail containing
a releasable follower backed with
a spring, elastically coupling into the concave of the said inner race;
the said special hinge bearing 05 being configured normally to allow the working-part 04 to skew to center-to-bolt radius line of the arm 01 about 30° then swing out 90°;
and a centrifugal governor 06 to work with the said special hinge bearing 05 for disengaging excess wind, including a proper weight, a lever with support and connection to the follower of said special hinge bearing 05.

3. A windmill as defined in claim 2, wherein the control on every working member's movement is merely due to its response to the wind exerted on it;
each working member flips and engages the favorable wind twice in about ¾ rotation of the central axis but disengages in the rest ¼ rotation to go into the unfavorable wind like a weather vane;
or in case of excessive wind, the special hinge bearings OS and centrifugal governors 06 would allow the working members to skip one or more turns of work and go directly to temporary idle position then continue to turn around to the next working position.

4. A device as defined in claims 2-3, wherein the working fluid could be other than wind, e.g. water current as well.
